(19) United States
(12) Patent Application Publication
(10) Pub. No.: US 2010/0110859 A1
(43) Pub. Date: May 6, 2010

(54) ARCHIVAL OPTICAL DISC ARRAYS

(75) Inventors: Douglas P. Hansen, Spanish Fork, UT (US); Henry J. O'Connell, Spanish Fork, UT (US); Mark O. Worthington, Montrose, CA (US)

Correspondence Address: Pepper/Millenniata, 50th Floor, 500 Grant Street, Pttsburgh, PA, 15219-2502, US

(73) Assignee: MILLENNIATA, INC., Springville, UT (US)

(21) Appl. No.: 12/610,072

(22) Filed: Oct. 30, 2009

Related U.S. Application Data
(60) Provisional application No. 61/197,738, filed on Oct. 30, 2008.

(51) Int. Cl. G11B 7/24

(52) U.S. Cl. 369/100; G9B/7.139

(57) ABSTRACT

Optical disc arrays containing optical discs, disc drive devices, and a disc array controller are disclosed. The optical discs are suitable for archiving, unlike conventional media used in RAID or other array systems.

### CROSS REFERENCE TO RELATED APPLICATIONS

The present application claims priority to U.S. Provisional Patent Application Ser. No. 61/197,738 filed Oct. 30, 2008, the contents of which are incorporated herein by reference.

### FIELD OF THE INVENTION

The invention relates to optical disc arrays and, more specifically, to optical disc arrays useful for archiving data.

### DESCRIPTION OF RELATED ART

RAID array systems are widely used to store electronic data in a RW (re-writable) format. RAID is an acronym for “Redundant Array of Inexpensive Discs”, or alternatively, “Redundant Array of Independent Discs.” The systems simultaneously use two or more hard disk drives to achieve high levels of performance, reliability, and data volume sizes. RAID arrays distribute data across multiple disks, but the system is viewed operationally as a single high capacity disc.

Multiple RAID configurations exist, indicated by a suffix number. Common configurations include RAID 0, RAID 1, and RAID 5. The following descriptions of the RAID configurations are taken from WIKIPEDIA®. RAID systems use various combinations of “mirroring”, the copying of data to more than one disk; “striping”, the splitting of data across more than one disk; and “error correction”, where redundant data is stored to allow problems to be detected and possibly fixed (known as fault tolerance). WIKIPEDIA®, 2009, http://en.wikipedia.org/wiki/RAID.

RAID 0 (striped disks without parity/non-redundant array) distributes data across several disks in a way that gives improved speed and full capacity, but all data on all disks will be lost if any one disk fails. This provides improved performance and additional storage but no fault tolerance. Any disk failure destroys the array, which becomes more likely with more disks in the array. A single disk failure destroys the entire array because when data is written to a RAID 0 drive, the data is broken into fragments. The number of disks in the array dictates the number of fragments. The fragments are written to their respective disks simultaneously on the same sector. This allows smaller sections of the entire chunk of data to be read off the drive in parallel, giving this type of arrangement huge bandwidth. RAID 0 does not implement error checking so any error is unrecoverable. More disks in the array means higher bandwidth, but greater risk of data loss. RAID 0 requires at least two discs in the array.

RAID 1 (mirrored disks without parity) could be described as a backup solution, using two (possibly more) disks that each store the same data so that data is not lost as long as one disk survives. Total capacity of the array is just the capacity of a single disk. The failure of one drive, in the event of a hardware or software malfunction, does not increase the chance of a failure nor decrease the reliability of the remaining drives (second, third, etc.). This provides fault tolerance from disk errors and failure of all but one of the drives. Increased read performance occurs when using a multi-threaded operating system that supports split seeks, very small performance reduction when writing. The array continues to operate so long as at least one drive is functioning. Using RAID 1 with a separate controller for each disk is sometimes called duplexing. RAID 1 requires at least two discs in the array.

RAID 5 (striped disks with distributed parity) combines three or more discs in a way that protects data against loss of any one disc; the storage capacity of the array is reduced by one disk. Distributed parity requires all drives but one to be present to operate; drive failure requires replacement, but the array is not destroyed by a single drive failure. Upon drive failure, any subsequent reads can be calculated from the distributed parity such that the drive failure is masked from the end user. The array will have data loss in the event of a second drive failure and is vulnerable until the data that was on the failed drive is rebuilt onto a replacement drive.

RAID systems were first described in U.S. Pat. No. 4,092,732 (issued May 30, 1978). In the last 30 years, the market for these systems has grown to multi-billions of dollars. RAID is widely used by a variety of industries and government agencies.

Despite the widespread application of RAID arrays, users still need to perform regular tape backups of their systems. RAID does not protect against multiple disc failures. Failures could be due to mechanical failure of a hard drive system, software errors, human errors, or environmental disasters. RAID is valuable, but is not designed to be an archival system. Accordingly, there exists a need for an arrayed archival system to complement RAID or other systems.

### SUMMARY OF THE INVENTION

An array containing optical discs, disc drive devices, and at least one disc array controller is disclosed. The optical disc array provides permanent archiving, high data transfer rates, and eliminates the need for redundancy used in existing systems.

### DESCRIPTION OF THE FIGURES

The following figures form part of the present specification and are included to further demonstrate certain aspects of the present invention. The invention may be better understood by reference to one or more of these figures in combination with the detailed description of specific embodiments presented herein.

FIG. 1 shows an optical disc array having “N” housing units, where N is an integer of two or more. Each housing unit contains a single optical disc. Disc drive devices in the housing units are coupled to a disc array controller.

FIG. 2 shows an optical disc array having a single housing unit. The housing unit contains “n” number of optical discs, where n is an integer of two or more. Disc drive devices in the housing unit are coupled to a disc array controller.

FIG. 3 shows an optical disc array containing aspects of the arrays of FIGS. 1 and 2. The array contains M different housing units, where M is an integer of two or more. Each housing unit contains “n” number of optical discs, where “n” is an integer of one or more, provided that at least one of the “n” values is an integer of two or more. The various “n” values can be the same or different. Disc drive devices in the different housing units are coupled to a disc array controller.

### DETAILED DESCRIPTION OF THE INVENTION

While compositions and methods are described in terms of “comprising” various components or steps (interpreted as meaning “including, but not limited to”), the compositions and methods can also “consist essentially of” or “consist of” the various components and steps. The “consist essentially of” or “consist of” terminology should be interpreted as defining essentially closed-member groups.

Materials

Embodiments of the invention may include or use digital information storage media of any of a variety of types. One example of digital information media suitable for embodiments of the invention comprises optical discs.

One embodiment of the present invention is directed towards an optical disc array. The array can comprise two or more optical discs, two or more disc drive devices, and at least one disc array controller coupled to the disc drive devices. The array is configured for permanent, write-once, archival storage of data, unlike the erasable and re-writable format of currently existing RAID arrays.

The array can comprise any number of optical discs and disc drive devices. There is no theoretical maximum for the number of optical discs and disc drive devices. Specific examples of the number of optical discs are 2, 3, 4, 5, 6, 7, 8, 9, 10, 11, 12, 13, 14, 15, 16, 17, 18, 19, 20, 30, 40, 50, 60, 70, 80, 90, 100, 200, 300, 400, 500, 600, 700, 800, 900, 1000, and so on. Specific examples of the number of disc drive devices are 2, 3, 4, 5, 6, 7, 8, 9, 10, 11, 12, 13, 14, 15, 16, 17, 18, 19, 20, 30, 40, 50, 60, 70, 80, 90, 100, 200, 300, 400, 500, 600, 700, 800, 900, 1000, and so on. Typically, the number of disc drive devices will be the same as the number of optical discs. For example, ten optical discs would be used with ten disc drive devices, and 200 optical discs would be used with 200 disc drive devices.

The optical discs are capable of having data stored in them once inserted into the disc drive devices. The optical discs can have data written to a particular location on the disc only once. In other words, the discs are not erasable or re-writable. These types of discs are sometimes referred to as “write once read forever” discs. The selection of this type of optical disc provides for long term permanent archiving of stored data in an array format. The optical discs can be individually removed from the array. Alternatively, the optical discs can be added or removed from the array in combination, where several or all of the discs can be added or removed in a single action. Optical discs can be removed or added directly, or they can be removed or added while contained in a cartridge or other casing. In some embodiments, the optical discs to be added or removed could be grouped into a common package or carrier such as, for example a cartridge for ease of handling and for other benefits. Optical discs are different from non-optical systems such as magnetic tapes and hard drives.

The optical discs can generally be any shape and size. The optical discs are typically flat and round in shape. Currently envisioned sizes are about 8 cm diameter, about 12 cm diameter (like a conventional CD or DVD), about 13 cm diameter, about 20 cm diameter, about 10 inch (about 25.4 cm) diameter, about 26 cm diameter, and about 12 inch (about 30.48 cm) diameter.

The disc drive devices function to both read and write data from or to the optical discs. The disc drive devices can function on one side of the optical discs (“single sided”), or can function on both sides of the optical discs (“dual sided”). The disc drive devices can comprise one read device or two or more read devices. The disc drive devices can comprise one write device or two or more write devices. The read device and write device typically incorporate lasers or laser diodes to provide the light energy used to write and to read the disc, but anything capable of applying sufficient light energy to the optical discs in order to read or write data can be used. Additional optical components such as mirrors, prisms, and lenses can be used to condition, focus, and detect the energy used to read, and to condition and focus the energy used for writing. The read device and write device can be the same device or different devices. The write device preferably does not physically contact the optical discs. The read device preferably does not physically contact the optical discs. Each disc can have multiple layers of data on each side (such as 1, 2, 3, 4, 5, 6, 7, 8, or more layers per side). The disc drive devices can read and write data from any of the multiple layers.

The disc drive devices can comprise additional mechanical elements such as a rotation device to spin the optical discs, and at least one positioning device to move the read device or write device relative to the surface of the optical discs.

The disc array is preferably capable of transferring data to or from the array at a high transfer rate. Higher transfer rates are preferred. It is preferred that the transfer rate be at least about 250 MB/second. Examples of specific transfer rates include at least about 250 MB/second, at least about 300 MB/second, at least about 350 MB/second, at least about 400 MB/second, at least about 450 MB/second, at least about 500 MB/second, at least about 600 MB/second, at least about 700 MB/second, at least about 800 MB/second, at least about 900 MB/second, at least about 1,000 MB/second, at least about 1,500 MB/second, and at least about 2,000 MB/second.

The disc array controller functions to control writing of data to the array and reading of data from the array. One example of a disc array controller is software running on an operating system. A second example of a disc array controller is firmware running on a central processing unit (CPU) associated with the array. A third example of a disc array controller is an application specific integrated circuit (ASIC) that functions to handle computationally intensive tasks separately from a CPU.

The disc array controller will control the operation of the array and how data is written to or read from the array. For example, the disc array controller could function similar to the common RAID 0 definition, the common Raid 2 definition, or the common RAID 5 definition.

In general, the purpose of the disc array controller is to distribute data as it is written to a number of discs in the array in a manner to increase the over-all transfer rate of the data to the array and to provide data redundancy (if desired) by writing data to multiple discs simultaneously. In addition, the disc array controller could implement various error recovery strategies in the way data is written to the array.

Also, in general, the purpose of the disc array controller is to allow data to be read from the array by gathering the data together from the various discs and disc locations where it is written so that the data is reassembled into an output data stream that is identical to the input data stream. In addition, the disc array controller would implement any error recovery strategies required to recover the data in case of an error.

The disc array preferably operates only when data is being actively written to the array or read from the array. This operation confers reduced energy consumption relative to other array systems that must operate continuously.

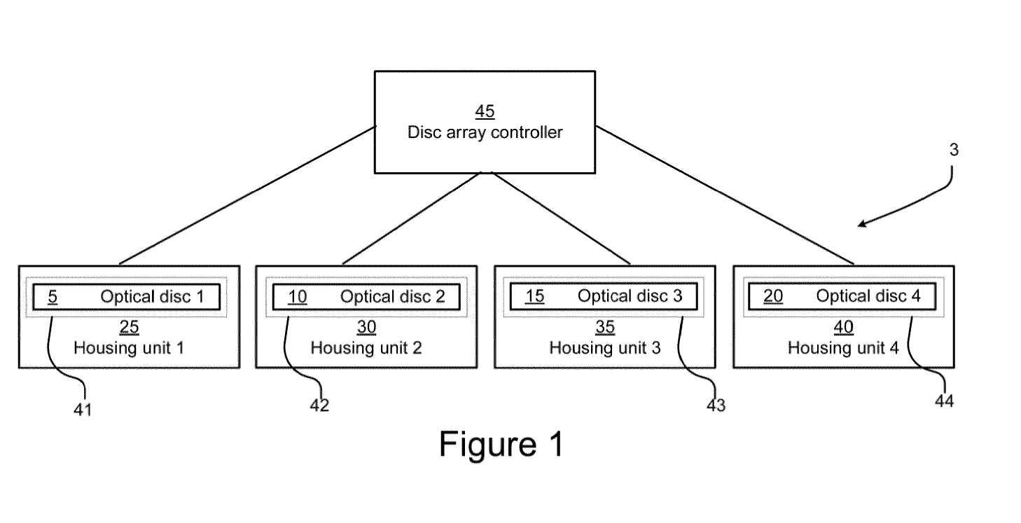

The disc array can be configured in a variety of manners. The optical discs can be housed in a single housing unit, or in multiple housing units. Three possible configurations are described below, and are shown in FIGS. 1-3.

In a first embodiment, the array 3 comprises multiple optical discs 5, 10, 15, 20, each individually housed in separate housing units 25, 30, 35, 40. Each housing unit 25, 30, 35, 40 would contain one disc drive device 41, 42, 43, 44. At least one disc array controller 45 would be coupled to the multiple disc drive devices 41, 42, 43, 44. The at least one disc array controller 45 can be contained in one or more of the housing units 25, 30, 35, 40, or can be separate from the housing units 25, 30, 35, 40. This embodiment is shown in FIG. 1.

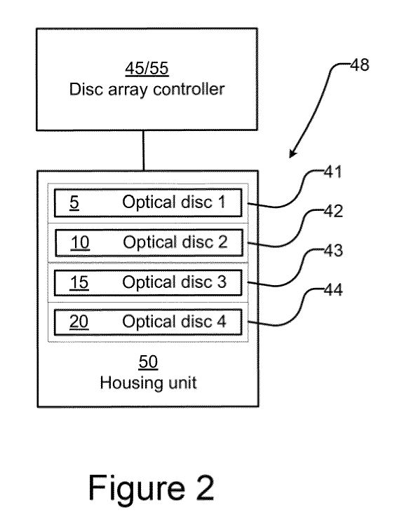

In a second embodiment, the array 48 comprises multiple optical discs 5, 10, 15, 20 housed in a single housing unit 50. The single housing unit 50 would contain multiple disc drive devices 41, 42, 43, 44. At least one disc array controller 45, 55 would be coupled to the multiple disc drive devices 41, 42, 43, 44. The at least one disc array controller 45, 55 can be contained in the housing unit 50, or can be separate from the housing unit 50. This embodiment is shown in FIG. 2.

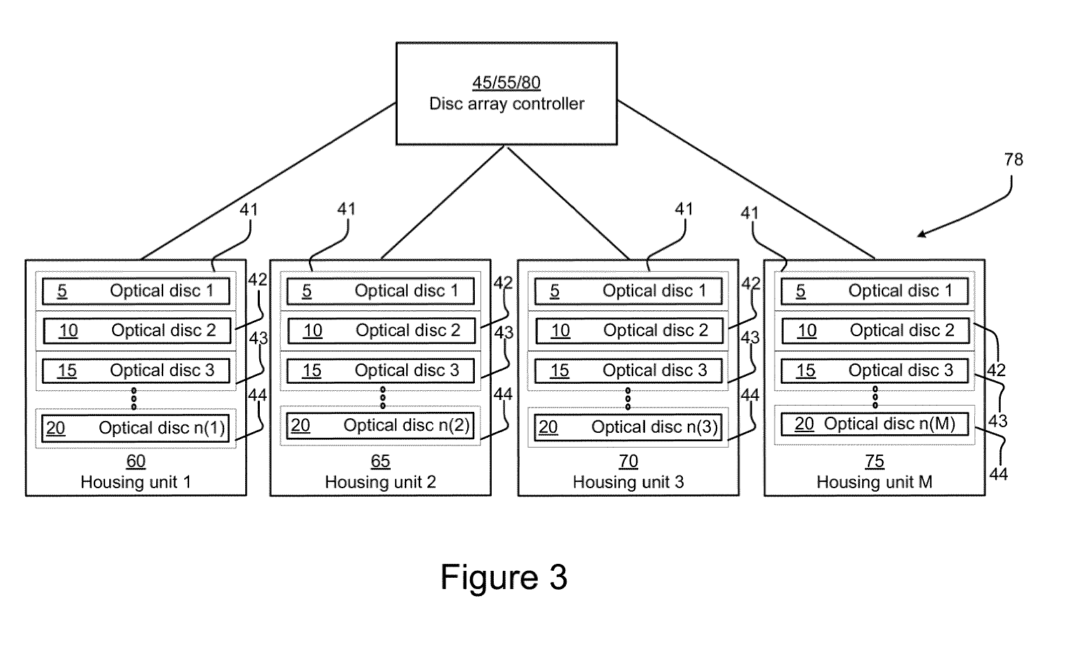

A third embodiment combines aspects of the first and second embodiments. In this embodiment, the array 78 comprises multiple housing units 60, 65, 70, 75 each comprising multiple optical discs 5, 10, 15, 20 and multiple disc drive devices 41, 42, 43, 44. The number of optical discs in different housing units can be the same or different. At least one disc array controller 45, 55, 80 would be coupled to the multiple disc drive devices 41, 42, 43, 44. This embodiment is shown in FIG. 3.

In all of the configurations, each housing unit 25, 30, 35, 40, 50, 60, 65, 70, 75 is randomly selectable, each optical disc 5, 10, 15, 20 is randomly selectable, and each disc drive device 41, 42, 43, 44 is randomly searchable, meaning that the surface of each optical disc 5, 10, 15, 20 can be scanned continuously, or piecewise, in a particular order, or in no particular order, depending on which method is most effective for the particular application. Data can also be read from the optical discs 5, 10, 15, 20 in the array in a randomly selective manner.

Each optical disc array 3, 48, 78 and/or individual disc 5, 10, 15, 20 can be individually labeled with a unique identification code. The identification code can generally be any identification code that allows a user to distinguish one disc array or individual disc from another disc array or individual disc. One example of an identification code is a scannable barcode. An additional example of an identification code is an radio frequency identification (RFID) tag. A third example of an identification code is a computer readable chip that is assigned a unique identification tag. The unique identification code can be affixed directly to the optical disc array 3, 48, 78 or individual disc 5, 10, 15, 20, or permanently encoded into the optical disc array 3, 48, 78 or individual disc 5, 10, 15, 20. Alternatively, the unique identification code can be affixed to a cartridge, other casing, or carrier for the optical disc array or individual disc.

Since the data written to an optical disc array 3, 48, 78 cannot be read from any single disc of the array in many, if not all, of the possible array configurations that could be useful, it is very desirable to store or archive the individual discs 5, 10, 15, 20 composing an optical disc array 3, 48, 78 in a manner to ensure that the entire array can be re-assembled when the archived data is desired to be read. This is one advantage of the unique identification code when applied to individual discs 5, 10, 15, 20. It is also an advantage to configure the optical disc array 3, 48, 78 to be contained within a cartridge or carrier device to ensure that the individual discs 5, 10, 15, 20 of the array cannot be separated from one another.

The presence of a unique identification code allows a user to easily determine the position of a particular optical disc while it is in the optical disc array 3, 48, 78, and after the optical disc is removed from the optical disc array 3, 48, 78. This is particularly advantageous when the user stores an optical disc array outside of or removed from the optical disc device array 3, 48, 78 for the purpose of archiving the data written to the array.

The storage area for the optical disc array 3, 48, 78 can be configured to provide traceability or tracking for the optical disc array 3, 48, 78 by interacting in various ways with the identification code attached to the optical disc array 3, 48, 78. For example, the room could be equipped with an RFID device to scan the RFID tags located in the room to provide an immediate inventory of all the RFID tags in the room upon demand and hence an immediate inventory of all the disc arrays located in the storage room. A second example would be to use a bar code reader to log a bar-coded disc array into and out of a storage location in order to provide traceability of the individual disc arrays. A third example would be to provide a storage rack with appropriate electrical connections and network connectivity so that the disc array cartridge or carrier equipped with a computer-readable identification chip could be continuously in contact with, or could be queried on demand by a network device in order to provide traceability and searchability to the disc array package or cartridge. In this way, the position of a particular disc array in the storage or archive facility could always be known.

Methods of Preparation

Additional embodiments of the invention are directed towards methods of preparing an optical disc array.

In one embodiment, the method can comprise providing two or more disc drive devices, and coupling at least one disc array controller to the disc drive devices.

In a second embodiment, the method can comprise providing two or more disc drive devices, and at least one disc array controller coupled to the disc drive devices, and inserting two or more optical discs into the disc drive devices to form an optical disc array. The number of optical discs inserted can be any number up to and including the number of disc drive devices.

The disc drive devices can be any of the disc drive devices discussed above. The optical discs can be any of the optical discs discussed above.

Methods of Use

An additional embodiment of the invention is directed towards methods of using an optical disc array for storing data. The method can comprise providing two or more disc drive devices for storing data, and at least one disc array controller coupled to the disc drive devices, inserting two or more optical discs into the disc drive devices to form an optical disc array, and storing data in the optical discs. The number of optical discs inserted can be any number up to and including the number of disc drive devices. The methods can further comprise reading data from the optical discs after the storing step. The methods can further comprise removing at least one of the optical discs from the array after the storing step. Optical discs can be removed individually or all at once. The removed discs can be stored for archival purposes and read at a later time. The removed discs can be replaced in the array with new, unwritten discs.

An alternative embodiment of the invention is directed towards methods of using an optical disc array for storing data. The method can comprise providing an optical disc array, and storing data in the array. The array can comprise two or more optical discs, two or more disc drive devices, and at least one disc array controller coupled to the disc drive devices. The methods can further comprise removing at least one of the optical discs from the array after the storing step. Optical discs can be removed individually or all at once. The removed discs can be stored for archival purposes and read at a later time. The removed discs can be replaced in the array with new, unwritten discs.

The disc drive devices can be any of the disc drive devices discussed above. The optical discs can be any of the optical discs discussed above.

In all of the above-described methods of use, the methods can further comprise individually labeling each optical disc with a unique identification code, either before data is written to the disc or after data is written to the disc. After the disc is removed from the optical disc array, it can be later identified and located by its identification code. The methods can further comprise preparing an index of the unique identification codes. The methods can still further comprise preparing an index of the unique identification codes and the physical storage location of the optical discs after they are removed from the optical disc array. In this manner, a user always knows the location or position of the optical discs. Alternatively, the methods can further comprise labeling the entire set of optical discs with one unique identification code, either before data is written to the discs or after data is written to the discs.

All of the compositions and/or methods and/or processes and/or apparatus disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and/or apparatus and/or processes and in the steps or in the sequence of steps of the methods described herein without departing from the concept and scope of the invention. More specifically, it will be apparent that certain agents which are both chemically and physically related may be substituted for the agents described herein while the same or similar results would be achieved. All such similar substitutes and modifications apparent to those skilled in the art are deemed to be within the scope and concept of the invention.

What is claimed is:

1. An optical disc array comprising:
two or more disc drive devices;
two or more optical discs; and
at least one disc array controller coupled to the disc drive devices; wherein:
the optical discs can have data stored in them;
the optical discs cannot have data erased or rewritten to a particular location on the disc to which data has been previously written;
the optical discs are removable individually or as a group from the optical disc array; and
each disc drive device comprises at least one of a read device and a write device.

2. The optical disc array of claim 1, wherein the read device comprises a laser or a laser diode.

3. The optical disc array of claim 1, wherein the write device comprises a laser or a laser diode.

4. The optical disc array of claim 1, wherein each disc drive device comprises two or more read devices.

5. The optical disc array of claim 1, wherein each disc drive device comprises two or more write devices.

6. The optical disc array of claim 1, wherein the number of optical discs and the number of disc drive devices is the same.

7. The optical disc array of claim 1, comprising 2, 3, 4, 5, 6, 7, 8, 9, 10, 11, 12, 13, 14, 15, 16, 17, 18, 19, 20, 30, 40, 50, 60, 70, 80, 90, 100, 200, 300, 400, 500, 600, 700, 800, 900, or 1000 disc drive devices.

8. The optical disc array of claim 1, comprising 2, 3, 4, 5, 6, 7, 8, 9, 10, 11, 12, 13, 14, 15, 16, 17, 18, 19, 20, 30, 40, 50, 60, 70, 80, 90, 100, 200, 300, 400, 500, 600, 700, 800, 900, or 1000 optical discs.

9. The optical disc array of claim 1, wherein the disc array controller comprises at least one of software, firmware, and an application specific integrated circuit (ASIC).

10. The optical disc array of claim 1, wherein the disc array controller comprises an application specific integrated circuit (ASIC).

11. The optical disc array of claim 1, wherein the controller and the drive devices are configured such that data can be transferred to or from the array at a transfer rate of at least about 250 MB/second.

12. The optical disc array of claim 1, wherein the optical discs are flat and round in shape and comprise a diameter from among about 8 cm, about 12 cm, about 13 cm, about 10 inch (about 25.4 cm), and about 12 inch (about 30.48 cm).

13. The optical disc array of claim 1, wherein the optical discs are housed in a single housing unit.

14. The optical disc array of claim 1, wherein the optical discs are housed in multiple housing units.

15. The optical disc array of claim 1, wherein the optical discs are housed in multiple housing units, with each housing unit containing one optical disc.

16. The optical disc array of claim 1, wherein the optical discs are housed in multiple housing units, with each housing unit containing multiple optical discs.

17. The optical disc array of claim 1, wherein the optical discs are randomly selectable and randomly searchable.

18. The optical disc array of claim 1, wherein the optical discs are individually labeled with unique identification codes.

19. The optical disc array of claim 1, wherein each disc drive device comprises at least one read device and at least one write device.

20. A method for preparing an optical disc array, the method comprising:
providing two or more disc drive devices and at least one disc array controller coupled to the disc drive devices; and
inserting two or more optical discs into the disc drive devices to form an optical disc array; wherein:
the optical discs can have data stored in them;
the optical discs cannot have data erased or rewritten to a particular location on the disc to which data has been previously written;
the optical discs are removable from the optical disc array; and
each disc drive device comprises at least one of a read device and a write device.

21. The method of claim 20, wherein the disc drive devices are housed in a single housing unit.

22. The method of claim 20, wherein the disc drive devices are housed in multiple housing units.

23. The method of claim 20, further comprising individually labeling the optical discs with unique identification codes.

24. The method of claim 20, wherein the optical discs are removable individually or as a group from the optical disc array.

25. The method of claim 20, wherein each disc drive device comprises at least one read device and at least one write device.

26. A method for storing data in an optical disc array, the method comprising:
providing an array comprising:
two or more disc drive devices;
two or more optical discs; and
at least one disc array controller coupled to the disc drive devices; and
storing data in the optical discs; wherein:
the optical discs can have data stored in them;
the optical discs cannot have data erased or rewritten to a particular location on the disc to which data has been previously written;
the optical discs are removable from the optical disc array; and
each disc drive device comprises at least one of a read device and a write device.

27. The method of claim 26, further comprising reading data from the array after the storing step.

28. The method of claim 26, further comprising removing at least one of the optical discs from the array after the storing step.

29. The method of claim 26, wherein the disc drive devices are housed in a single housing unit.

30. The method of claim 26, wherein the disc drive devices are housed in multiple housing units.

31. The method of claim 26, wherein the optical discs are individually removable from the optical disc array.

32. The method of claim 26, further comprising individually labeling the optical discs with unique identification codes.

33. The method of claim 26, further comprising reading data from the optical discs in the array in a randomly selective manner.

34. The method of claim 26, wherein each disc drive device comprises at least one read device and at least one write device.
